(19) United States
(12) Patent Application Publication
(10) Pub. No.: US 2026/0177965 A1
(43) Pub. Date: Jun. 25, 2026

(54) IMAGE FORMING APPARATUS

(71) Applicant: CANON KABUSHIKI KAISHA, Tokyo (JP)

(72) Inventors: MIREI AOYAMA, Chiba (JP); AKIHITO YOKOTE, Chiba (JP); HIROAKI ISHIDA, Tokyo (JP); TATSUOMI MURAYAMA, Chiba (JP); TADASHI FUKUDA, Tokyo (JP); TAKENORI SUEOKA, Ibaraki (JP); SHOHEI OKUMURA, Tokyo (JP)

(21) Appl. No.: 19/429,105

(22) Filed: Dec. 22, 2025

(30) Foreign Application Priority Data
Dec. 24, 2024 (JP) 2024-227522

(51) Int. Cl. G03G 15/00; G03G 15/01

(52) U.S. Cl. CPC G03G 15/5062; G03G 15/0189; G03G 2215/00063; G03G 2215/00067

(57) ABSTRACT

An image forming apparatus includes a plurality of image forming units configured to form images using toners of a plurality of colors, the plurality of image forming units including a first image forming unit configured to form an image using a first toner, and a second image forming unit configured to form an image using a second toner different from the first toner, an image bearing member configured to bear the images formed by the plurality of image forming units, a conveying member configured to convey a sheet to a nip portion for transferring the images on the image bearing member onto the sheet, and a controller configured to control the plurality of image forming units to form a detection image for detecting an image density.

### BACKGROUND

### Field of the Technology

The present disclosure relates to an image forming apparatus, such as a copying machine, a multifunction peripheral, or a printer.

### Description of the Related Art

In recent years, the market of an on-demand image forming apparatus has been expanding. Such an image forming apparatus adopts an electrophotographic system that is expanding also in an offset printing market, or an inkjet system that has succeeded in expanding into a broad range of markets such as large format, low initial cost, and very high speed. However, market expansion is not easy, and it is required to maintain a quality of an image (hereinafter referred to as “image quality”) of related-art image forming apparatus that have been played a central role in the market.

In the image forming apparatus adopting the electrophotographic system, variations in hue are caused by variations in environmental conditions such as a temperature and a humidity, a change over time of a component, reduction in performance due to durability of a component, or the like. The hue affects the image quality of an output image. In a photosensitive drum which is a photosensitive member having a drum shape and including a photosensitive layer on its surface, sensitivity unevenness of the photosensitive layer causes image density unevenness and color unevenness of the output image. In an exposing device for irradiating the photosensitive drum with laser light, edge drop of an exposure amount of laser light and lens aberration of an optical system cause the image density unevenness and the color unevenness of the output image. In a developing device for developing an electrostatic latent image formed on the photosensitive drum, development unevenness causes the image density unevenness and the color unevenness of the output image. In a transfer unit for transferring a toner image formed on the photosensitive drum, transfer unevenness causes the image density unevenness and the color unevenness of the output image.

In U.S. Pat. No. 7,609,909 , there is disclosed a technology of correcting the image density unevenness in a main scanning direction based on measurement results of a plurality of pattern images arranged side by side in the main scanning direction. In Japanese Patent Application Laid-open No. 2000-98675, there is disclosed a technology of correcting the image density unevenness in a sub-scanning direction which is caused in a rotation period of a developing sleeve. The developing sleeve is a member that is rotated in association with the rotation of the photosensitive drum to cause toner to adhere to the electrostatic latent image. Toner is caused to adhere to the electrostatic latent image by applying a developing bias voltage to the developing sleeve. The image density unevenness in the sub-scanning direction is caused by rotation of a rotary member such as the photosensitive drum, in addition to the developing sleeve.

A measurement image to be used to detect the image density unevenness is formed of pattern images of a plurality of colors in order to reduce the number of sheets on which the measurement image is printed. However, in a case where the pattern images of a plurality of colors are arranged in each sheet, a luminance difference is caused between adjacent pattern images. Further, a margin is required to be provided in order to ensure the quality of the image. In this case, a luminance difference is caused between a margin and a pattern image adjacent to the margin. In a case where an optical sensor is used as a reading device for reading the measurement image, a luminance difference between adjacent regions causes a flare to be generated to narrow an effective detection region of an image density. Accordingly, there is a possibility that a detection accuracy of the image density unevenness is reduced. The present disclosure has an object to suppress image density unevenness in a sub-scanning direction with high accuracy even in a case where a luminance difference between adjacent regions is large.

### SUMMARY

An image forming apparatus according to one embodiment of the present disclosure includes a plurality of image forming units configured to form images using toners of a plurality of colors, the plurality of image forming units including a first image forming unit configured to form an image using a first toner, and a second image forming unit configured to form an image using a second toner different from the first toner, an image bearing member configured to bear the images formed by the plurality of image forming units, a conveying member configured to convey a sheet to a nip portion for transferring the images on the image bearing member onto the sheet, and a controller configured to control the plurality of image forming units to form a detection image for detecting an image density, wherein the detection image includes a plurality of pattern images arranged side by side in an intersecting direction intersecting with a conveying direction of the sheet conveyed by the conveying member, wherein the sheet having the detection image formed thereon has blank regions in which no image is formed, on outer sides of the plurality of pattern images in the intersecting direction, wherein the plurality of pattern images on the sheet include a first pattern image adjacent to one of the blank regions in the intersecting direction, the first pattern image being formed by the first image forming unit and another first pattern image prevented from being adjacent to the first pattern image in the intersecting direction, the another first pattern image being prevented from being adjacent to any one of the blank regions, the another first pattern image being formed by the first image forming unit, and wherein the first pattern image has a width in the intersecting direction larger than a width of the another first pattern image in the intersecting direction.

An image forming apparatus according to another embodiment of the present disclosure includes a plurality of image forming units configured to form images using toners of a plurality of colors, the plurality of image forming units including a first image forming unit configured to form an image using a first toner and a second image forming unit configured to form an image using a second toner different from the first toner, an image bearing member configured to bear the images formed by the plurality of image forming units, a conveying member configured to convey a sheet to a nip portion for transferring the images on the image bearing member onto the sheet, and a controller configured to control the plurality of image forming units to form a detection image for detecting an image density, wherein the detection image includes a plurality of pattern images arranged side by side in an intersecting direction intersecting with a conveying direction of the sheet conveyed by the conveying member, and wherein the plurality of pattern images on the sheet include a first pattern image formed at a position closest to a first edge of the sheet in the intersecting direction among the plurality of pattern images, the first pattern image being formed by the first image forming unit a second pattern image formed at a position closest to a second edge opposite to the first edge of the sheet in the intersecting direction among the plurality of pattern images, the second pattern image being formed by the second image forming unit, another first pattern image having a distance from the first edge of the sheet in the intersecting direction farther than a distance from the first edge to the first pattern image, the another first pattern image having a distance from the second edge of the sheet in the intersecting direction farther than a distance from the second edge to the second pattern image, the another first pattern image being formed by the first image forming unit, the first pattern image having a width in the intersecting direction larger than a width of the another first pattern image in the intersecting direction, and another second pattern image having a distance from the second edge of the sheet in the intersecting direction farther than the distance from the second edge to the second pattern image, the another second pattern image having a distance from the first edge of the sheet in the intersecting direction farther than the distance from the first edge to the first pattern image, the another second pattern image being formed by the second image forming unit, the second pattern image having a width in the intersecting direction larger than a width of the another second pattern image in the intersecting direction.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration view for illustrating an image forming apparatus.

FIG. 2 is a configuration explanatory view for illustrating an image forming unit.

FIG. 3 is an exemplary view for illustrating a measurement image.

FIG. 4 is an exemplary view for illustrating a measurement image.

FIG. 5A and FIG. 5B are explanatory graphs for showing luminance profiles.

FIG. 6A and FIG. 6B are explanatory graphs for showing luminance profiles.

FIG. 7 is a flow chart for illustrating processing of correcting image density unevenness.

FIG. 8 is an explanatory view for illustrating detection positions.

FIG. 9 is an exemplary graph for showing a luminance-density conversion table.

FIG. 10 is an exemplary view for illustrating a measurement image.

FIG. 11A and FIG. 11B are exemplary diagrams for showing image density unevenness.

FIG. 12 is an exemplary view for illustrating a measurement image.

FIG. 13A and FIG. 13B are explanatory graphs for showing luminance profiles.

### DESCRIPTION OF THE EMBODIMENTS

Embodiments of the present disclosure are described with reference to the drawings. In the embodiments, as an example, a laser beam printer employing an electrophotographic system is described as an image forming apparatus. However, the image forming apparatus is not limited to the laser beam printer, and may be a printer other than the laser beam printer, such as a light emitting diode (LED) printer, as long as the electrophotographic system is employed. In any case, the embodiments are effective as long as the image forming apparatus uses a rotary member for image formation.

### First Embodiment

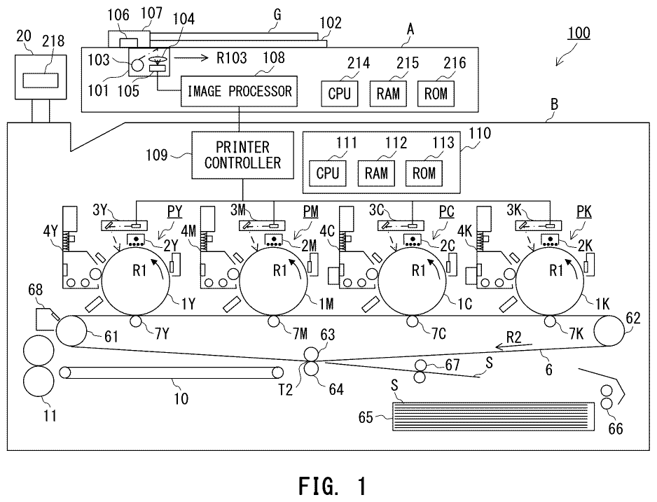

FIG. 1 is a configuration view for illustrating an image forming apparatus of a first embodiment of the present disclosure. An image forming apparatus 100 includes a reader A, a printer B, and an operation unit 20. The printer B prints an image on a sheet S. The reader A reads an image from a sheet (original G) having an image printed thereon. The operation unit 20 is a user interface. The operation unit 20 includes various key buttons or a touch panel as an input interface. The operation unit 20 includes a display unit 218 as an output interface. A user uses the operation unit 20 to give an instruction to start copying or perform various settings.

### Reader

The reader A includes a platen 102 for placing the original G thereon, a light source 103 for irradiating the original G placed on the platen 102 with light, an optical system 104, a light receiver 105, and an image processor 108. The reader A further includes a central processing unit (CPU) 214, a random access memory (RAM) 215, and a read only memory (ROM) 216. The light source 103, the optical system 104, and the light receiver 105 form an image reading unit 101 for reading an image of the original G. A positioning member 107 and a reference white plate 106 are arranged at an edge portion of the platen 102. The positioning member 107 allows one side of the original G to be brought into abutment thereagainst to prevent oblique arrangement of the original G. The reference white plate 106 is to be used for shading correction of the image reading unit 101.

The optical system 104 causes reflected light, which is the light applied from the light source 103 and reflected by the original G, to be imaged on a reading face of the light receiver 105. The light receiver 105 includes a plurality of photoelectric conversion elements such as charge coupled device (CCD) sensors, and outputs an image signal obtained by converting the received reflected light into an electric signal. The light receiver 105 includes, for example, photoelectric conversion elements arranged in three rows so as to correspond to red (R), green (G), and blue (B). The light receiver 105 generates color component signals of respective colors including R, G, and B as image signals. The image reading unit 101 reads lines of the image on the original G placed on the platen 102 one after another while moving in an arrow direction R103. The plurality of photoelectric conversion elements are arranged side by side in line in a direction intersecting with the arrow direction R103. The direction intersecting with the arrow direction R103 in which the photoelectric conversion elements are arranged side by side is a main scanning direction at the time of reading an image by the reader A, and the arrow direction R103 is a sub-scanning direction.

The image signals generated in the light receiver 105 are input to the image processor 108. The image processor 108 performs image processing such as A/D conversion, shading correction, and color conversion on the image signals acquired from the light receiver 105. The image processor 108 transmits the image signals having been subjected to the image processing to the printer B.

The CPU 214 executes a computer program stored in the ROM 216 to control the operation of the reader A. The RAM 215 is a work memory used when the CPU 214 executes the processing. The reader A is controlled by the CPU 214 to perform various operations for reading the image of the original G.

The light receiver 105 generates, from reflected light reflected by the original G, a luminance value of each color of R, G, or B as an image signal. The image processor 108 converts the luminance value acquired from the light receiver 105 into an image density value. For the conversion into the image density value, for example, look-up tables (luminance-density conversion tables LUTid_r, LUTid_g, LUTid_b, and LUTid_k) for converting the luminance value into the image density value, which are to be described later, are used. In the first embodiment, the image processor 108 generates density data representing an 8-bit image density value.

### Printer

The printer B includes image forming units PY, PM, PC, and PK that form images of a plurality of colors, an intermediate transfer belt 6, a secondary transfer roller 64, a fixing device 11, a sheet feeding cassette 65, and a printer controller 109. The printer B is a full-color printer of a tandem intermediate transfer type in which the image forming units PY, PM, PC, and PK are arranged along the intermediate transfer belt 6. The image forming unit PY forms a yellow image (toner image). The image forming unit PM forms a magenta image (toner image). The image forming unit PC forms a cyan image (toner image). The image forming unit PK forms a black image (toner image).

The intermediate transfer belt 6 is an image bearing member having an endless belt shape and wrapped around and supported by a tension roller 61, a drive roller 62, and an opposing roller 63. A belt cleaner 68 is provided so as to be opposed to the tension roller 61. The intermediate transfer belt 6 is driven by the drive roller 62 to rotate in an arrow R2 direction at a predetermined process speed. The images (toner images) respectively formed by the image forming units PY, PM, PC, and PK are sequentially superimposed and transferred onto the intermediate transfer belt 6 at timings set in accordance with a rotation speed of the intermediate transfer belt 6. In this manner, a full-color image (toner image) is formed on the intermediate transfer belt 6.

The opposing roller 63 forms a secondary transfer portion T2 at a nip portion between the opposing roller 63 and the secondary transfer roller 64. The images of the respective colors having been transferred onto the intermediate transfer belt 6 are conveyed to the secondary transfer portion T2 and collectively transferred onto the sheet S. Through application of a DC voltage having a positive polarity to the secondary transfer roller 64, the images (toner images) of the respective colors charged to a negative polarity and borne on the intermediate transfer belt 6 are collectively transferred onto the sheet S. A developer (transfer residual toner) that remains on the intermediate transfer belt 6 after the transfer is removed by the belt cleaner 68. The belt cleaner 68 rubs a cleaning blade against the intermediate transfer belt 6 to collect transfer residual toner remaining on the intermediate transfer belt 6 after passing through the secondary transfer portion T2.

Sheets S are stored in the sheet feeding cassette 65 and fed one after another. On a conveyance passage for conveying the sheets S, separation rollers 66 and registration rollers 67 are provided. The sheets S are fed from the sheet feeding cassette 65, separated into individual sheets by the separation rollers 66, and conveyed to the registration rollers 67. The registration rollers 67 receive the sheet S in a stopping state and allow the sheet S to stand by. The registration rollers 67 then convey the sheet S to the secondary transfer portion T2 in accordance with a timing at which the image borne on the intermediate transfer belt 6 is conveyed to the secondary transfer portion T2. The registration rollers 67 function as a conveying unit for conveying the sheet S.

The sheet S having the image transferred thereto is conveyed by the secondary transfer roller 64 to the fixing device 11 via a conveyance belt 10. The fixing device 11 applies heat and pressure to the sheet S so that the image melts to be fixed to the sheet S. The sheet S having the image fixed thereto is discharged to an outside of a machine body of the printer B.

Image formation performed by the image forming units PY, PM, PC, and PK is described. The image forming units PY, PM, PC, and PK have substantially the same configuration to perform the same operation, except that colors of the developers (in this case, toners) used for development are different. In the following description, letters Y, M, C, and K are added to ends of the reference symbols in a case where the colors are distinguished, and the letters Y, M, C, and K at the ends of the reference symbols are omitted in a case where the colors are not distinguished.

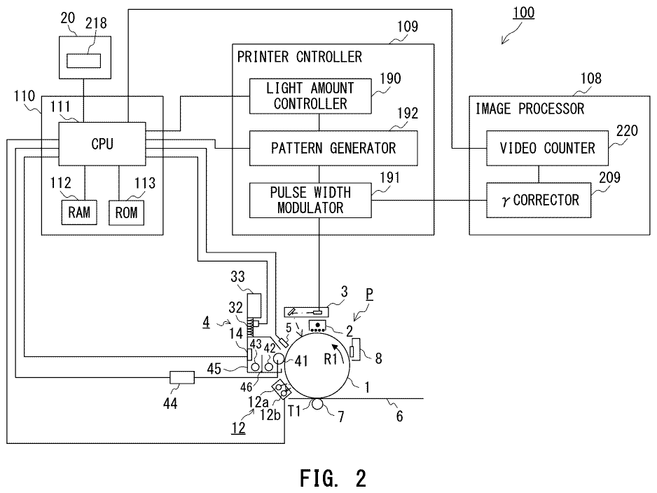

FIG. 2 is a configuration explanatory view for illustrating an image forming unit P. The image forming unit P includes a photosensitive drum 1, a charging device 2, an exposing device 3, a developing device 4, a reflected light amount sensor 12, a primary transfer roller 7, and a drum cleaner 8. The intermediate transfer belt 6 is sandwiched between the photosensitive drum 1 and the primary transfer roller 7. The charging device 2, the exposing device 3, the developing device 4, the reflected light amount sensor 12, the primary transfer roller 7, and the drum cleaner 8 are arranged around the photosensitive drum 1.

The photosensitive drum 1 in the first embodiment is an image bearing member having a drum shape and having a configuration in which a photosensitive layer having a negative charging polarity is formed on an outer peripheral surface (surface) of an aluminum cylinder. The photosensitive drum 1 rotates in an arrow R1 direction about a drum shaft at a predetermined process speed. The photosensitive drum 1 is, for example, an organic photo conductor (OPC) photosensitive member having a reflectance of about 40% with respect to near-infrared light (960 nm). The photosensitive drum 1 may be, for example, an amorphous-silicon-based photosensitive member having substantially the same reflectance.

The charging device 2 in the first embodiment is a scorotron charging device, which irradiates the photosensitive drum 1 with charged particles generated by corona discharge to charge the photosensitive layer on the surface of the photosensitive drum 1 to a uniform negative electric potential. The scorotron charging device includes a wire to which a high voltage is to be applied, a grounded shield portion, and a grid portion to which a desired voltage is to be applied. A predetermined charging bias voltage is applied to the wire of the charging device 2 from a charging bias power source (not shown). A predetermined grid bias voltage is applied to the grid portion of the charging device 2 from a grid bias power source (not shown). Although it depends on the voltage applied to the wire, the photosensitive drum 1 is charged substantially to the voltage applied to the grid portion.

The exposing device 3 scans the surface of the charged photosensitive drum 1 in a drum shaft direction by reflecting laser light with a rotary mirror, to thereby form an electrostatic latent image on the surface of the photosensitive drum 1. Accordingly, the drum shaft direction (axial direction of a rotation axis) of the photosensitive drum 1 corresponds to the main scanning direction. The sub-scanning direction intersecting with the main scanning direction corresponds to the rotation direction of the photosensitive drum 1. The sub-scanning direction is also a direction parallel to a conveying direction in which the sheet S is conveyed by the registration rollers 67. Further, the main scanning direction and the sub-scanning direction of the printer B are the same as the main scanning direction and the sub-scanning direction of the reader A, respectively. In the vicinity of the photosensitive drum 1, a potential sensor 5 serving as a potential detector is provided. The potential sensor 5 can detect the electric potential of the electrostatic latent image formed on the photosensitive drum 1. The exposing device 3 is not limited to having a configuration in which laser light is deflected through use of a polygon mirror, and may have a configuration in which the photosensitive drum 1 is exposed with exposure light emitted from a plurality of light emitting points arrayed along the main scanning direction.

Through application of a development bias voltage to the developing device 4, the developing device 4 causes toner to adhere to the electrostatic latent image on the photosensitive drum 1, thereby forming an image (toner image) on the photosensitive drum 1. The developing device 4 includes, in a developer container 45 for storing the toner, a developing sleeve 41, a first conveyance screw 42, and a second conveyance screw 43. The developer container 45 in the first embodiment stores a two-component developer in which non-magnetic toner and magnetic carriers are mixed. The developer container 45 is divided into two chambers by a partition wall 46. The first conveyance screw 42 is provided in one chamber, and the second conveyance screw 43 is provided in the other chamber. The partition wall 46 has openings formed at two portions, and mutual inflow of the toner is allowed between the two chambers through the openings. The first conveyance screw 42 and the second conveyance screw 43 rotate to cause the developer to circulate in the developer container 45 while being stirred and mixed.

The developing sleeve 41 is arranged close to the photosensitive drum 1, and is rotated in association with the photosensitive drum 1. The developing sleeve 41 carries the developer in which the toner and the carriers are mixed. The developer carried by the developing sleeve 41 develops the electrostatic latent image on the photosensitive drum 1 through application of the development bias voltage to the developing sleeve 41. The development bias voltage is applied by a power supply unit 44. The power supply unit 44 is controlled by a controller 110 (CPU 111) to be described later to control the application of the development bias voltage.

The developing device 4 includes a toner amount sensor 14 for measuring the toner amount in the developer container 45. For example, a magnetic permeability sensor for detecting the magnetic permeability of the developer is used as the toner amount sensor 14. The developing device 4 is connected to a toner replenishment container 33 through a replenishment passage 32. In a case where a measurement result of the toner amount obtained by the toner amount sensor 14 is smaller than a predetermined amount, the toner is supplied from the toner replenishment container 33 to the developer container 45 via the replenishment passage 32.

The reflected light amount sensor 12 is an optical sensor including a light emitter 12a and a light receiver 12b, and is used for measuring the image density of the toner image formed on the photosensitive drum 1. The reflected light amount sensor 12 irradiates the toner image on the photosensitive drum 1 with light from the light emitter 12a. The light receiver 12b receives reflected light reflected by the toner image, and outputs an output signal corresponding to the received reflected light amount.

The primary transfer roller 7 presses an inner surface of the intermediate transfer belt 6 to form a primary transfer portion T1 between the photosensitive drum 1 and the intermediate transfer belt 6. Through application of a DC voltage having a positive polarity to the primary transfer roller 7, a toner image having a negative polarity borne on the photosensitive drum 1 is transferred onto the intermediate transfer belt 6 passing through the primary transfer portion T1. In the manner described above, the image forming unit P forms a toner image of a corresponding color on the photosensitive drum 1. The toner image is transferred from the photosensitive drum 1 onto the intermediate transfer belt 6. The drum cleaner 8 rubs a cleaning blade against the photosensitive drum 1 to collect the transfer residual toner remaining on the photosensitive drum 1 after the transfer onto the intermediate transfer belt 6.

The operation of such an image forming unit P is controlled by the printer controller 109 and the controller 110 provided in the printer B. The printer controller 109 controls the operation of the printer B. The controller 110 controls the operation of the entire image forming apparatus 100. The controller 110 is connected to the printer controller 109 and the image processor 108 of the reader A. Further, the operation unit 20 is connected to the controller 110. The operation unit 20 is also connected to the CPU 214 of the reader A. Although not shown, the controller 110 is also connected to the CPU 214 of the reader A.

The controller 110 includes the CPU 111, a RAM 112, and a ROM 113. The CPU 111 executes a computer program stored in the ROM 113 to control the operation of the image forming apparatus 100. The RAM 112 is a work memory used in a case where the CPU 111 executes the processing. Various operations of the reader A and the printer B of the image forming apparatus 100 are controlled by the CPU 111. The printer controller 109 includes a light amount controller 190, a pattern generator 192, and a pulse width modulator 191. The image processor 108 includes a video counter 220 and a γ corrector 209.

The exposing device 3 in the first embodiment is a laser scanner including a rotary mirror. The exposing device 3 has an exposure amount determined by the light amount controller 190 in order to obtain a predetermined image density value with respect to a laser output signal. In the first embodiment, in order to suppress the image density unevenness in the sub-scanning direction, an exposure amount setting (LPW) is managed by allowing the exposure amount to be set in the unit of about 23.59 mm in each direction. Further, the exposing device 3 outputs laser light in accordance with a pulse width determined by the pulse width modulator 191 based on a drive signal generated using a tone correction table (LUT) of the γ corrector 209.

The laser output signal is determined based on the tone correction table held by the γ corrector 209. The tone correction table represents a relationship between the laser output signal and the image density value of the image to be formed, and the laser output signal is determined in accordance with the image density of the image to be formed.

The printer controller 109 acquires the image signal generated by the image processor 108. The printer controller 109 subjects the laser light output from the exposing device 3 based on the image signal to pulse width modulation (PWM) to form an image having an image density tone based on area coverage modulation. Accordingly, the printer controller 109 generates and outputs, by the pulse width modulator 191, a laser output signal having a width (time width) corresponding to the level of the image signal of each pixel. The laser output signal is a laser drive pulse signal. For an image signal specifying a high image density, the laser output signal becomes a pulse signal having a wide width. For an image signal specifying a low image density, the laser output signal becomes a pulse signal having a narrow width. For an image signal specifying an intermediate image density, the laser output signal becomes a pulse signal having an intermediate width.

The printer controller 109 can acquire not only the image signal generated by the image processor 108, but also an image signal by a receiver (not shown). This receiver can acquire, for example, an image signal transmitted by a fax machine via a telephone line or an image signal transmitted by an external apparatus via a predetermined network. The predetermined network is a data communication network such as a local area network (LAN) or a wide area network (WAN). The external apparatus is an information processing apparatus such as a personal computer.

The laser output signal (laser drive pulse signal) output from the pulse width modulator 191 is supplied to a light source (for example, a semiconductor laser) of the laser light of the exposing device 3. The semiconductor laser outputs the laser light for a time period corresponding to the pulse width of the laser output signal. Accordingly, the semiconductor laser is driven for a long time period for a pixel having a high image density, and is driven for a short time period for a pixel having a low image density. Thus, the dot size (area) of the electrostatic latent image formed on the photosensitive drum 1 varies depending on the image density of the pixel. The exposing device 3 performs exposure in a range longer in the main scanning direction for the pixel having a high image density, and performs exposure in a range shorter in the main scanning direction for the pixel having a low image density.

The pattern generator 192 generates an image signal for a measurement image (detection image) formed to correct the image forming condition. In a case where the measurement image is formed, the pulse width modulator 191 generates a laser output signal based on the image signal for the measurement image acquired from the pattern generator 192. The measurement image in the first embodiment is, for example, an image for correcting the image density unevenness in the sub-scanning direction or an image for correcting the image density.

### Shading Function

In the first embodiment, the image density unevenness in the sub-scanning direction is corrected (suppressed) using a shading function included in the exposing device 3. The exposing device 3 having the shading function can correct (suppress) the image density unevenness in the main scanning direction by adjusting an exposure amount (LPW) of laser light during one scanning period. The light amount controller 190 acquires, from the ROM 113 of the controller 110, a correction value of an exposure amount corresponding to each exposure position (position in the main scanning direction) and a phase in the sub-scanning direction, and controls the exposure by means of exposure amount setting that is based on this correction value. The correction value of the exposure amount corresponding to each exposure position is obtained through processing of correcting the image density unevenness, which is to be described later. In the first embodiment, the ROM 113 stores correction values for the exposure amount setting at an interval of about 23.59 mm in the sub-scanning direction. The image density unevenness in the main scanning direction is handled by shading correction in the main scanning direction. In the shading correction in the main scanning direction, the light amount controller 190 acquires, from the ROM 113 of the controller 110, the correction value of the exposure amount corresponding to each exposure position in the main scanning direction, and controls the exposure by means of the exposure amount setting that is based on this correction value.

### Measurement Image

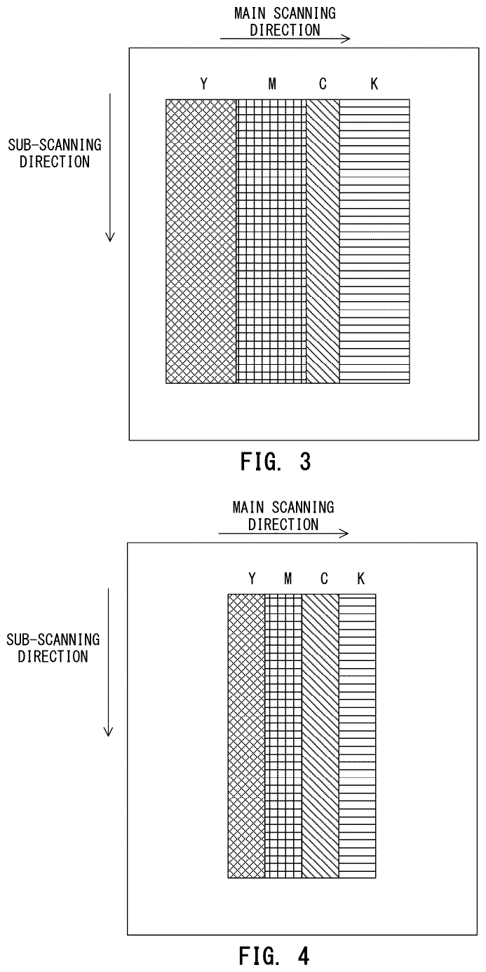

FIG. 3 is an exemplary view for illustrating a measurement image for measuring an image density in the sub-scanning direction. In the first embodiment, as an example, a measurement image is printed on a sheet S having the A3 size (420 mm×297 mm). The main scanning direction and the sub-scanning direction (conveying direction (moving direction) of the intermediate transfer belt 6) at the time of forming the measurement image are as indicated by the arrows of FIG. 3. The size of the sheet S on which the measurement image is formed is not limited to the A3 size.

The measurement image in the first embodiment is formed of pattern images of yellow (Y), magenta (M), cyan (C), and black (K) arranged at predetermined intervals in the main scanning direction. In the first embodiment, the pattern images of the measurement image formed on the sheet are read by the reader A. The reader A acquires information about the image density of each pattern image of the measurement image. The image density of each pattern image of the measurement image formed on the sheet may be measured by, for example, an external color measuring device. As another example, an optical sensor may be provided on the downstream side of the fixing device 11 in the conveying direction of the sheet S, and the image density of each pattern image of the measurement image formed on the sheet may be detected using the optical sensor.

Each pattern image of the measurement image is a band-shaped image (band image) having a predetermined width in the main scanning direction and extending to have a predetermined length in the sub-scanning direction, and is formed based on an image signal indicating a uniform image density. This image signal is generated by the pattern generator 192. The band images (pattern images) of the respective colors (Y, M, C, and K) are arranged adjacent to each other in the main scanning direction. In FIG. 3, the pattern images are arranged in the main scanning direction in the order of yellow (Y), magenta (M), cyan (C), and black (K), but the arrangement is not limited thereto.

The pattern images of the respective colors have different widths in the main scanning direction. The width of the pattern image (band image) is determined based on a difference in luminance value (luminance difference) between regions adjacent to each other in the main scanning direction. In a case where the band images arranged in the main scanning direction are read by the reader A, due to an influence of a flare, a region in which the difference between the luminance value corresponding to the image density indicated by the image signal and the luminance value obtained from the result of measuring the measurement image falls within ±2% (effective detection region) is narrowed. As a result, the detection error of the luminance value of the band image is increased, and hence the correction accuracy of the image density unevenness is reduced. Accordingly, the measurement image in the first embodiment includes a plurality of pattern images (band images) having different widths so that the effective detection region is prevented from being narrowed. Thus, the detection error of the luminance value is decreased, thereby suppressing reduction in the correction accuracy of the image density unevenness. Specifically, the pattern image is formed so that the width of the pattern image becomes larger as the luminance difference from the adjacent region becomes larger. In the first embodiment, a threshold value of the difference in luminance value for determining the effective detection region is set to ±2%, but the threshold value is not limited to this value.

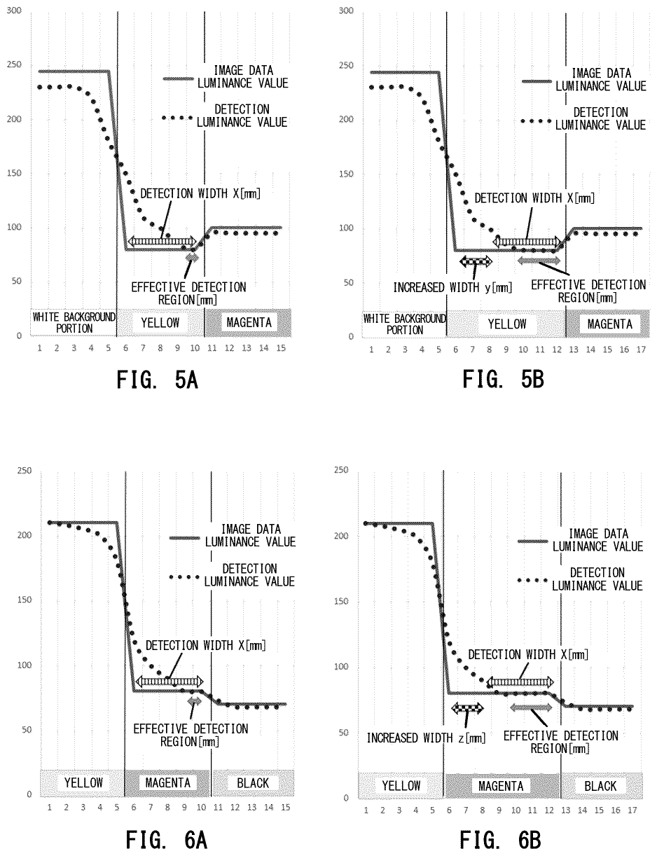

FIG. 4 is an exemplary view for illustrating the measurement image in a case in which the respective pattern images have the same width. That is, FIG. 4 shows a case in which the width of the band image is not adjusted based on the luminance difference between the adjacent regions. FIG. 5A, FIG. 5B, FIG. 6A, and FIG. 6B are explanatory graphs for showing luminance profiles obtained from the results of reading the measurement images.

In FIG. 5A, a luminance profile that is based on results of reading the measurement image of FIG. 4 formed on the sheet S having the A3 size is shown as an example. In FIG. 5B, a luminance profile that is based on results of reading the measurement image of FIG. 3 formed on the sheet S having the A3 size is shown as an example.

An average value in the sub-scanning direction of the image densities of each region, that is, a white background portion (blank region) having a background color of the margin of the sheet S, the yellow pattern image, or the magenta pattern image, is calculated based on the results (image densities) of reading the measurement image. With the average value being subjected to blue (B) filtering, a luminance value (detection luminance value) is generated. The luminance profiles of FIG. 5A and FIG. 5B are obtained by plotting this detection luminance value. The image data luminance values of FIG. 5A, FIG. 5B, FIG. 6A, and FIG. 6B are luminance values corresponding to the image densities indicated by the image signal.

In FIG. 5A, the difference in luminance value between the white background portion and the yellow pattern image is large, and, due to an influence of a flare, a width of an effective detection region in the main scanning direction is narrowed. In a case where the luminance values obtained by reading a detection width of “X” mm are averaged for the yellow pattern image, while the image data luminance value is “80,” the detection luminance value is “105,” and the detection error of the luminance value is “25.” Accordingly, the accuracy of correcting the image density unevenness is reduced to cause overcorrection.

In FIG. 5B, the difference in luminance value between the white background portion and the yellow pattern image is large, and there is an influence of a flare, but the width of the yellow pattern image is increased to reduce the influence of the flare as compared to FIG. 5A. In the first embodiment, the influence of the flare corresponds to an increased width of “y” mm. Accordingly, with the width of the yellow pattern image being increased by the increased width of “y” mm as compared to the case of FIG. 4, the effective detection region is increased by the same amount. With the width of the pattern image being increased by an amount corresponding to the influence of the flare, and the luminance values obtained by reading the detection width of “X” mm being averaged, while the image data luminance value is “80,” the detection luminance value is “85,” and the detection error of the luminance value is “5”. Through reduction in the detection error of the luminance value from “25” to “5”, the image density unevenness correction can be more accurately performed as compared to the case of FIG. 5A.

In FIG. 6A, a luminance profile that is based on results of reading the measurement image of FIG. 4 formed on the sheet S having the A3 size is shown as an example. In FIG. 6B, a luminance profile that is based on results of reading the measurement image of FIG. 3 formed on the sheet S having the A3 size is shown as an example.

The average value in the sub-scanning direction of the image densities of each region, that is, the yellow pattern image, the magenta pattern image, or the black pattern image in the main scanning direction is calculated based on the results (image densities) of reading the measurement image by the reader A. The luminance value (detection luminance value) is generated by subjecting the average value to green (G) filtering. The luminance profiles of FIG. 6A and FIG. 6B are obtained by plotting this detection luminance value.

In FIG. 6A, the difference in luminance value between the yellow pattern image and the magenta pattern image is large, and, due to an influence of a flare, a width of an effective detection region in the main scanning direction is narrowed. In a case where the luminance values obtained by reading a detection width of “X” mm are averaged for the magenta pattern image, while the image data luminance value is “80,” the detection luminance value is “94,” and the detection error of the luminance value is “16.”

In FIG. 6B, the difference in luminance value between the yellow pattern image and the magenta pattern image is large, and there is an influence of a flare, but the width of the magenta pattern image is increased to reduce the influence of the flare as compared to FIG. 6A. In the first embodiment, the influence of the flare corresponds to an increased width of “z” mm. Accordingly, with the width of the magenta pattern image being increased by the increased width of “z” mm as compared to the case of FIG. 4, the effective detection region is increased. With the width of the pattern image being increased by an amount corresponding to the influence of the flare, and the luminance values obtained by reading the detection width of “X” mm being averaged, while the image data luminance value is “80,” the detection luminance value is “82,” and the detection error of the luminance value is “2”. Through reduction in the detection error of the luminance value from “16” to “2”, the image density unevenness correction can be more accurately performed as compared to the case of FIG. 6A.

As described above, the region of the pattern image (the width of the band image) that is a measurement target is adjusted based on the difference in luminance value between a region being the measurement target and a region adjacent thereto. In this manner, the detection error to be caused by the flare of the reader A can be suppressed, and hence the image density unevenness in the sub-scanning direction can be corrected (suppressed) with high accuracy.

### Image Density Unevenness Correction

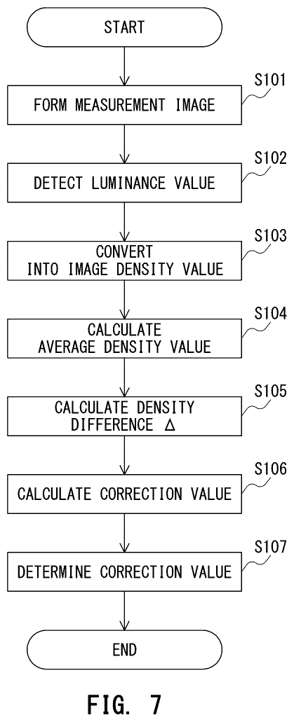

FIG. 7 is a flow chart for illustrating processing of correcting the image density unevenness in the sub-scanning direction. The image density unevenness in the sub-scanning direction is periodically caused by a rotary member involved in image formation, such as the photosensitive drum 1, the developing sleeve 41, or the primary transfer roller 7, in accordance with a rotation period of the rotary member. In the processing of correcting (suppressing) the image density unevenness in the sub-scanning direction, the image density unevenness in the sub-scanning direction is corrected by correcting the image forming condition (in this case, the exposure amount of laser light) in accordance with the period of the rotary member.

In a case where the controller 110 starts the processing of correcting the image density unevenness in the sub-scanning direction, the controller 110 forms a measurement image for measuring the image density in the sub-scanning direction on a sheet S (Step S101). The controller 110 forms the measurement image illustrated as an example in FIG. 3 on the sheet S. In the first embodiment, the pattern image of each color is formed based on an image signal indicating the image density of 40%.

As for the image forming condition in the sub-scanning direction, it is required to associate the position of the pattern image of the measurement image in the main scanning direction and the rotation phase of the rotary member that is the cause of the image density unevenness with each other. In the first embodiment, phase control of the image bearing member (in this case, the photosensitive drum 1) is performed so that a write start position of the pattern image and a home position of the rotation phase are controlled to match each other. In this manner, it is possible to associate the phase for one rotation of the image bearing member (in this case, the photosensitive drum 1) of each color with a specific position of the image density unevenness, and to obtain image density unevenness information representing image density unevenness corresponding to the phase of the image bearing member.

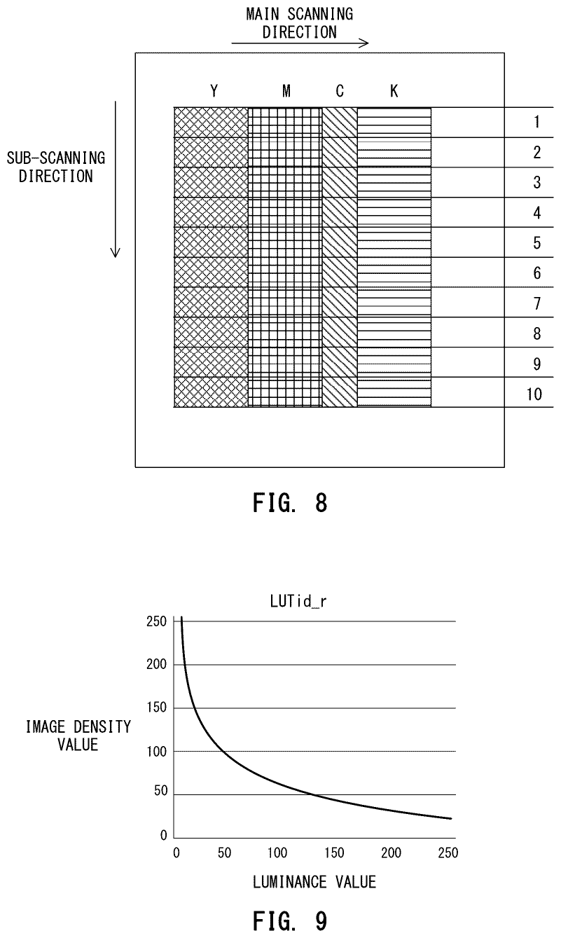

The user places the sheet S having the measurement image formed thereon onto the platen 102 to cause the reader A to read the measurement image. The reader A reads the measurement image formed on the sheet S to detect the luminance value representing the image density unevenness. FIG. 8 is an explanatory view for illustrating detection positions of the measurement image in the sub-scanning direction. The pattern image (measurement image) is detected in units obtained by equally dividing 300 mm corresponding to one or more periods of the image bearing member (photosensitive drum 1) into ten regions to obtain sections 1 to 10 for about every 30 mm from the upstream side in the conveying direction (sub-scanning direction).

The controller 110 causes the image processor 108 to detect the luminance value as a result of reading the sheet S having the measurement image formed thereon by the reader A (Step S102). The luminance value is detected by the reader A at each detection position described with reference to FIG. 8. The controller 110 causes the image processor 108 to convert the luminance value at each detection position detected from the measurement image into an image density value (Step S103). The controller 110 acquires the image density value at each detection position converted by the image processor 108.

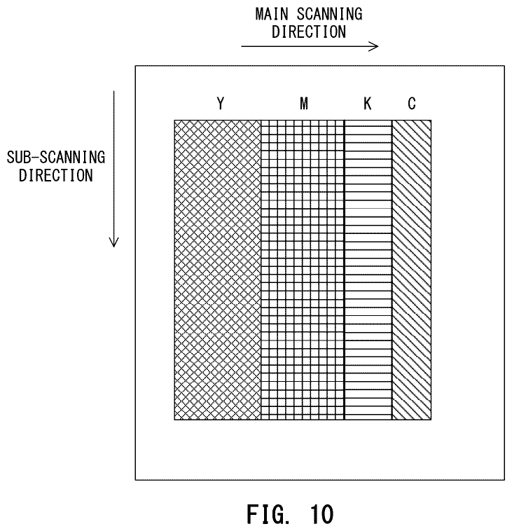

FIG. 9 is an exemplary graph for showing a luminance-density conversion table LUTid_r for converting the luminance value detected by the red (R) photoelectric conversion element of the reader A at the time of reading a cyan image into a cyan image density value. The image processor 108 uses the luminance-density conversion table LUTid_r to convert the luminance value into the image density value. Similarly, the luminance value of the magenta image is converted into an image density value using a luminance-density conversion table LUTid_g for converting the luminance value detected by the green (G) photoelectric conversion element. Similarly, the luminance value of the yellow image is converted into an image density value using a luminance-density conversion table LUTid_b for converting the luminance value detected by the blue (B) photoelectric conversion element. The luminance value of the black image is converted into an image density value using a luminance-density conversion table LUTid_k for converting the luminance value detected by the green (G) photoelectric conversion element.

The image processor 108 may convert the luminance value into the image density value using a mathematical expression representing the relationship of the luminance-density conversion tables LUTid_r, LUTid_g, LUTid_b, and LUTid_k. The conversion from the luminance value into the image density value using the luminance-density conversion tables LUTid_r, LUTid_g, LUTid_b, and LUTid_k may be performed in the controller 110. In this case, the controller 110 acquires the luminance value from the reader A to perform the conversion processing.

The controller 110 calculates an average value of ten image density values at the respective detection positions for each period of the photosensitive drum 1 (Step S104). The controller 110 calculates a density difference Δ between the average value of the image density values and the image density value of each of the detection positions (regions 1 to 10) (Step S105). The controller 110 calculates a correction value (ΔLPW) corresponding to the calculated density difference Δ (Step S106). The correction value (ΔLPW) corresponding to the density difference Δ is calculated through use of, for example, a correction coefficient database (described later) stored in advance.

The controller 110 averages the correction value (ΔLPW) calculated for each period of the photosensitive drum 1 by the acquired number of periods to determine the correction value (ΔLPW) of the exposure amount for correcting the image density unevenness in the sub-scanning direction caused by the photosensitive drum 1 (Step S107).

### Second Embodiment

A configuration of an image forming apparatus 100 of a second embodiment of the present disclosure is similar to that of the first embodiment, and hence description thereof is omitted. The second embodiment is different from the first embodiment in the measurement image.

In the measurement image in the first embodiment illustrated as an example in FIG. 3, one pattern image (band image) is arranged for each of yellow, magenta, cyan, and black, and the band widths of the pattern images each vary depending on the luminance difference between adjacent regions in order to prevent the influence of the flare. In the measurement image in the first embodiment, when the band width is increased, the consumption toner amount is increased, resulting in that the running cost is increased.

FIG. 10 is an exemplary view for illustrating a measurement image in the second embodiment. In the measurement image in the second embodiment, the band image adjacent to the white background portion is a band image of a color having a luminance value that has the smallest difference from the luminance value of the white background portion among the band images of the four colors. Specifically, the pattern images adjacent to the white background part of the sheet in the main scanning direction are yellow (Y) and cyan (C). The pattern images of other colors are sandwiched between the pattern images of yellow (Y) and cyan (C). The width of the pattern image of each color in the main scanning direction individually has a width determined in consideration of the influence of the flare. However, as compared to the measurement image in the first embodiment, the width of the pattern image tends to be narrowed. Using such pattern images, the increase in consumption toner amount due to the increase in band width can be suppressed. Accordingly, the increase in running cost can be suppressed.

### Third Embodiment

A configuration of an image forming apparatus 100 of a third embodiment of the present disclosure is similar to that of the first embodiment, and hence description thereof is omitted.

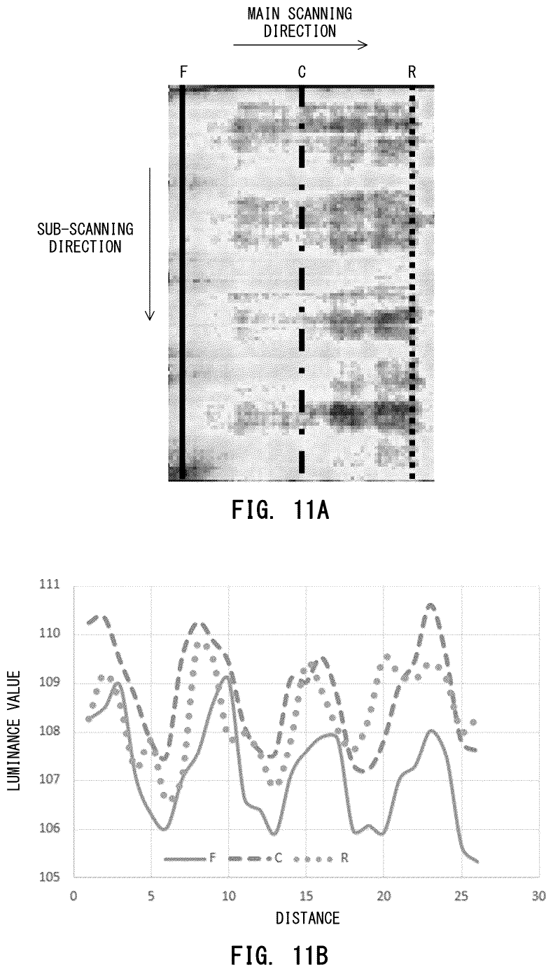

In some cases, the feature of the periodic image density unevenness in the sub-scanning direction of the image formed by the image forming apparatus 100 varies depending on the position in the main scanning direction. FIG. 11A and FIG. 11B are exemplary diagrams for showing the image density unevenness in the sub-scanning direction at each position in the main scanning direction. FIG. 11A shows the image density unevenness in the main scanning direction and the sub-scanning direction. FIG. 11B shows a variation of the luminance value at each position in the sub-scanning direction at each of positions F, C, and R in the main scanning direction of FIG. 11A.

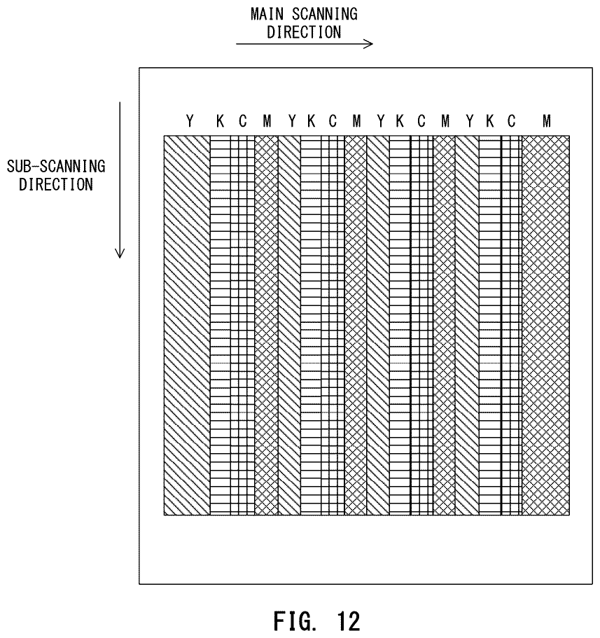

The feature of the image density unevenness in the sub-scanning direction varies depending on the position in the main scanning direction, and hence it is required to arrange a plurality of pattern images (band images) of the same color at positions different in the main scanning direction. FIG. 12 is an exemplary view for illustrating a measurement image in the third embodiment. In the measurement image in the third embodiment, an arrangement of colors of the pattern images has a repetition of yellow (Y), black (K), cyan (C), and magenta (M) in the main scanning direction. This arrangement of colors is set so that the difference in luminance value between adjacent regions is minimized. In the measurement image in the third embodiment, the pattern images of the respective colors are repeatedly arranged in the main scanning direction in this arrangement of colors.

The width of the pattern image of each color in the main scanning direction is individually a width corresponding to the luminance value between the adjacent regions. Accordingly, even the pattern images of the same color have different widths in the main scanning direction. In FIG. 12, the yellow pattern image at the left end is formed at a position closest to the left edge of the sheet S. The yellow pattern image at the left end is formed to be thicker than the widths of other yellow pattern images in the main scanning direction. The magenta pattern image at the right end is formed at a position closest to the right edge of the sheet S. The magenta pattern image at the right end is formed to be thicker than the widths of other magenta pattern images in the main scanning direction. A filter of a complementary color with respect to each color is used as a filter to be used in a case where the luminance value is acquired. With such an array of pattern images, the difference in luminance value from the adjacent region can be suppressed.

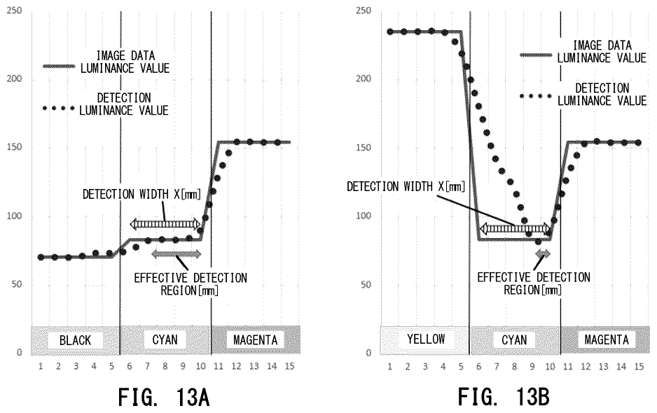

FIG. 13A and FIG. 13B are explanatory graphs for showing the luminance profiles obtained from the results of reading the measurement images. Description is given below of a case in which a red (R) filter having a complementary color is used to acquire a luminance value of a cyan pattern image.

FIG. 13A is a luminance profile in a case of an arrangement of black, cyan, and magenta pattern images. FIG. 13B is a luminance profile in a case of an arrangement of yellow, cyan, and magenta pattern images. In a case where the pattern images are arranged in consideration of the difference in luminance value detected from the adjacent region as illustrated in FIG. 13A, as compared to a case in which the pattern images are arranged without consideration of the luminance difference as illustrated in FIG. 13B, the effective detection region becomes wider. Accordingly, the influence of the flare of the reader A can be suppressed, and hence the image density unevenness correction can be performed with high accuracy.

In the example of FIG. 12, the pattern images are arranged in the order of yellow, black, cyan, and magenta from one direction (the left side) in the main scanning direction. In addition, the arrangement of the pattern images from one direction (the left side) in the main scanning direction may be in the order of black (K), cyan (C), magenta (M), and yellow (Y). Further, the same effect can be obtained even with the arrangement in the order of cyan (C), magenta (M), yellow (Y), and black (K), the arrangement in the order of magenta (M), yellow (Y), black (K), and cyan (C), or the arrangement in the order of yellow (Y), magenta (M), cyan (C), and black (K).

Using the measurement image described in each of the first embodiment to the third embodiment, the influence of the flare of the image reading device for optically reading an image, such as the reader A, can be suppressed, and hence the image density of the measurement image can be accurately measured. Accordingly, for example, the image density unevenness that is periodic in the sub-scanning direction can be corrected with high accuracy. As a result, the image density unevenness in the sub-scanning direction is suppressed with high accuracy.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-227522, filed Dec. 24, 2024, which is hereby incorporated by reference herein in its entirety.

What is claimed is:

1. An image forming apparatus comprising:
a plurality of image forming units configured to form images using toners of a plurality of colors, the plurality of image forming units including:
a first image forming unit configured to form an image using a first toner; and
a second image forming unit configured to form an image using a second toner different from the first toner;
an image bearing member configured to bear the images formed by the plurality of image forming units;
a conveying member configured to convey a sheet to a nip portion for transferring the images on the image bearing member onto the sheet; and
a controller configured to control the plurality of image forming units to form a detection image for detecting an image density,
wherein the detection image includes a plurality of pattern images arranged side by side in an intersecting direction intersecting with a conveying direction of the sheet conveyed by the conveying member,
wherein the sheet having the detection image formed thereon has blank regions in which no image is formed, on outer sides of the plurality of pattern images in the intersecting direction,
wherein the plurality of pattern images on the sheet include:
a first pattern image adjacent to one of the blank regions in the intersecting direction, the first pattern image being formed by the first image forming unit; and
another first pattern image prevented from being adjacent to the first pattern image in the intersecting direction, the another first pattern image being prevented from being adjacent to any one of the blank regions, the another first pattern image being formed by the first image forming unit, and
wherein the first pattern image has a width in the intersecting direction larger than a width of the another first pattern image in the intersecting direction.

2. The image forming apparatus according to claim 1,
wherein the plurality of image forming units further include a third image forming unit configured to form an image using a third toner that is different from both of the first toner and the second toner, and
wherein the another first pattern image has one side in the intersecting direction adjacent to a second pattern image formed by the second image forming unit, and another side in the intersecting direction adjacent to a third pattern image formed by the third image forming unit.

3. The image forming apparatus according to claim 1, wherein the controller is configured to control a density of the image to be formed by each of the plurality of image forming units based on the image density of the detection image.

4. The image forming apparatus according to claim 1, wherein the controller is configured to suppress density unevenness of the image to be formed by each of the plurality of image forming units based on the image density of the detection image.

5. The image forming apparatus according to claim 1,
wherein the plurality of image forming units further include a third image forming unit configured to form an image using a third toner that is different from both of the first toner and the second toner,
wherein the plurality of pattern images on the sheet further include:
a second pattern image formed by the second image forming unit, the second pattern image having one side in the intersecting direction adjacent to a third pattern image formed by the third image forming unit, and another side in the intersecting direction adjacent to further another first pattern image formed by the first image forming unit; and
another second pattern image adjacent to another one of the blank regions in the intersecting direction, the another second pattern image being formed by the second image forming unit, and
wherein the another second pattern image has a width in the intersecting direction larger than a width of the second pattern image in the intersecting direction.

6. The image forming apparatus according to claim 2,
wherein the plurality of image forming units further include a fourth image forming unit configured to form an image using a fourth toner that is different from any one of the first toner, the second toner, and the third toner,
wherein the plurality of pattern images on the sheet further include another second pattern image adjacent to another one of the blank regions in the intersecting direction, the another second pattern image being formed by the second image forming unit,
wherein the second pattern image has one side in the intersecting direction adjacent to the another first pattern image, and another side in the intersecting direction adjacent to a fourth pattern image formed by the fourth image forming unit, and
wherein the another second pattern image has a width in the intersecting direction larger than a width of the second pattern image in the intersecting direction.

7. The image forming apparatus according to claim 1, further comprising a reading unit configured to read a sheet having the detection image formed thereon,
wherein the controller is configured to detect a density of the detection image based on a result of the detection image read by the reading unit.

8. The image forming apparatus according to claim 1, wherein the first toner has a yellow color.

9. The image forming apparatus according to claim 1, wherein the detection image includes pattern images of a yellow color, a cyan color, a magenta color, and a black color.

10. The image forming apparatus according to claim 1, wherein each of the plurality of pattern images is a band image extending in the conveying direction.

11. An image forming apparatus comprising:
a plurality of image forming units configured to form images using toners of a plurality of colors, the plurality of image forming units including:
a first image forming unit configured to form an image using a first toner; and
a second image forming unit configured to form an image using a second toner different from the first toner;
an image bearing member configured to bear the images formed by the plurality of image forming units;
a conveying member configured to convey a sheet to a nip portion for transferring the images on the image bearing member onto the sheet; and
a controller configured to control the plurality of image forming units to form a detection image for detecting an image density,
wherein the detection image includes a plurality of pattern images arranged side by side in an intersecting direction intersecting with a conveying direction of the sheet conveyed by the conveying member, and
wherein the plurality of pattern images on the sheet include:
a first pattern image formed at a position closest to a first edge of the sheet in the intersecting direction among the plurality of pattern images, the first pattern image being formed by the first image forming unit;
a second pattern image formed at a position closest to a second edge opposite to the first edge of the sheet in the intersecting direction among the plurality of pattern images, the second pattern image being formed by the second image forming unit;
another first pattern image having a distance from the first edge of the sheet in the intersecting direction farther than a distance from the first edge to the first pattern image, the another first pattern image having a distance from the second edge of the sheet in the intersecting direction farther than a distance from the second edge to the second pattern image, the another first pattern image being formed by the first image forming unit,
the first pattern image having a width in the intersecting direction larger than a width of the another first pattern image in the intersecting direction; and
another second pattern image having a distance from the second edge of the sheet in the intersecting direction farther than the distance from the second edge to the second pattern image, the another second pattern image having a distance from the first edge of the sheet in the intersecting direction farther than the distance from the first edge to the first pattern image, the another second pattern image being formed by the second image forming unit,
the second pattern image having a width in the intersecting direction larger than a width of the another second pattern image in the intersecting direction.

12. The image forming apparatus according to claim 11,
wherein the plurality of image forming units further include a third image forming unit configured to form an image using a third toner that is different from both of the first toner and the second toner, and
wherein the another first pattern image has one side in the intersecting direction adjacent to the another second pattern image, and another side in the intersecting direction adjacent to a third pattern image formed by the third image forming unit.

13. The image forming apparatus according to claim 11, wherein the controller is configured to control a density of the image to be formed by each of the plurality of image forming units based on the image density of the detection image.

14. The image forming apparatus according to claim 11, wherein the controller is configured to suppress density unevenness of the images to be formed by the plurality of image forming units based on the image density of the detection image.

15. The image forming apparatus according to claim 11,
wherein the plurality of image forming units further include a third image forming unit configured to form an image using a third toner that is different from both of the first toner and the second toner,
wherein the plurality of pattern images on the sheet further include further another second pattern image formed by the second image forming unit, the further another second pattern image having one side in the intersecting direction adjacent to a third pattern image formed by the third image forming unit, and another side in the intersecting direction adjacent to further another first pattern image formed by the first image forming unit, and
wherein the width of the second pattern image in the intersecting direction is larger than a width of the further another second pattern image in the intersecting direction.

16. The image forming apparatus according to claim 12,
wherein the plurality of image forming units further include a fourth image forming unit configured to form an image using a fourth toner that is different from any one of the first toner, the second toner, and the third toner,
wherein the plurality of pattern images on the sheet further include a fourth pattern image formed by the fourth image forming unit, and
wherein the another second pattern image has one side in the intersecting direction adjacent to the another first pattern image, and another side in the intersecting direction adjacent to the fourth pattern image.

17. The image forming apparatus according to claim 11, further comprising a reading unit configured to read a sheet having the detection image formed thereon,
wherein the controller is configured to detect a density of the detection image based on a result of the detection image read by the reading unit.

18. The image forming apparatus according to claim 11, wherein both of the first pattern image and the another first pattern image have a yellow color.

19. The image forming apparatus according to claim 11, wherein the detection image includes pattern images of a yellow color, a cyan color, a magenta color, and a black color.

20. The image forming apparatus according to claim 11, wherein each of the plurality of pattern images is a band image extending in the conveying direction.
